(19) United States
(12) Patent Application Publication
(10) Pub. No.: US 2026/0027718 A1
(43) Pub. Date: Jan. 29, 2026

(54) CONTROL SYSTEM, ROBOT CONTROL APPARATUS, AND CONTROL METHOD

(71) Applicant: SEIKO EPSON CORPORATION, Tokyo (JP)

(72) Inventor: Dai TANAKA, MATSUMOTO-SHI (JP)

(21) Appl. No.: 19/275,852

(22) Filed: Jul. 21, 2025

(30) Foreign Application Priority Data
Jul. 24, 2024 (JP) 2024-118851

(51) Int. Cl. B25J 9/16

(52) U.S. Cl. CPC B25J 9/1674

(57) ABSTRACT

There is provided a control system includes: a robot control apparatus that controls an operation of a robot having a robot arm; and a transmission apparatus that transmits a safety confirmation signal indicating that it is confirmed that the robot is configured to be operated safely to the robot control apparatus, in which the robot control apparatus includes a safety confirmation signal acquisition section that acquires the safety confirmation signal, and a notification signal output section that generates and outputs a notification signal for notifying that safety confirmation is required until the safety confirmation signal acquisition section acquires the safety confirmation signal when power is supplied to the robot control apparatus.

### CROSS-REFERENCE TO RELATED APPLICATIONS

The present application is based on, and claims priority from JP Application Serial Number 2024-118851, filed Jul. 24, 2024, the disclosure of which is hereby incorporated by reference herein in its entirety.

### BACKGROUND OF THE INVENTION

### 1. Technical Field

The present disclosure relates to a control system, a robot control apparatus, and a control method.

### 2. Related Art

In recent years, in a factory, due to the increase in labor costs and labor shortages, work such as transport, manufacturing, processing, assembly, and inspection of a workpiece such as a machine part is performed by a robot system, and automation of work that was performed manually is progressing. Such robot systems require high levels of safety, and various measures are taken to ensure this.

For example, JP-A-2009-190103 discloses a semiconductor transport apparatus including a robot that transports a semiconductor and a casing that houses the robot. The casing has an opening portion for accessing the inside and a cover that is an opening/closing door for opening and closing the opening portion. In this robot system, when the cover is in the open state in a state where the power supply is in the ON state, the interlock operates, and the operation of the robot is stopped without a predetermined release operation. As a result, a human body or the like can be prevented from entering the casing from the opening portion and coming into contact with the robot during the operation, and the safety can be enhanced.

However, in the semiconductor transport apparatus of JP-A-2009-190103, the configuration is not such that the interlock operates when the power supply is turned from OFF to ON, and there is a risk that the robot may operate even when the cover is open when the power supply is turned ON. Moreover, even when the interlock is merely operated when the power supply is turned ON, it is difficult to say that high safety is ensured.

In addition, the operator may not notice a state where the cover is not completely closed (an open state or a half-open state), and the robot may stop operating for a long period of time, resulting in reduced productivity.

### SUMMARY OF THE INVENTION

According to an aspect of the present disclosure, there is provided a control system including: a robot control apparatus that controls an operation of a robot including a robot arm; and a transmission apparatus that transmits a safety confirmation signal indicating that it is confirmed that the robot is configured to be operated safely to the robot control apparatus, in which the robot control apparatus includes a safety confirmation signal acquisition section that acquires the safety confirmation signal, and a notification signal output section that generates and outputs a notification signal for notifying that safety confirmation is required until the safety confirmation signal acquisition section acquires the safety confirmation signal when power is supplied to the robot control apparatus.

According to another aspect of the present disclosure, a robot control apparatus that controls an operation of a robot having a robot arm, the robot control apparatus including: a safety confirmation signal acquisition section that acquires a safety confirmation signal indicating that the robot is configured to be operated safely; and a notification signal output section that generates and outputs a notification signal for notifying that safety confirmation is required until the safety confirmation signal acquisition section acquires the safety confirmation signal when the power is supplied to the robot control apparatus.

According to a still another aspect of the present disclosure, there is provided a control method of a robot control apparatus that controls an operation of the robot and includes a safety confirmation signal acquisition section that acquires a safety confirmation signal indicating that the robot having a robot arm is configured to be operated safely, the control method including: a first step of generating and outputting a notification signal for notifying that safety confirmation is required until the safety confirmation signal acquisition section acquires the safety confirmation signal when power is supplied to the robot control apparatus; and a second step of stopping an output of the notification signal and permitting an operation of the robot arm when acquiring the safety confirmation signal.

### BRIEF DESCRIPTION OF DRAWINGS

FIG. 1 is a schematic configuration diagram of a robot system including a control system according to a first embodiment of the present disclosure.

FIG. 2 is a block diagram of the robot system illustrated in FIG. 1.

FIG. 3 is a block diagram illustrating a hardware configuration example of the robot system illustrated in FIG. 1.

FIG. 4 is a plan view of a display section (notification section) included in a transmission apparatus illustrated in FIG. 1, and is a view illustrating a state where a notification screen is displayed.

FIG. 5 is a flowchart for describing an example of a control method according to the first embodiment of the present disclosure.

FIG. 6 is a flowchart for describing an example of a control method according to a second embodiment of the present disclosure.

FIG. 7 is a schematic configuration diagram of a robot system including a control system according to a third embodiment of the present disclosure.

FIG. 8 is a flowchart for describing an example of a control method according to the third embodiment of the present disclosure.

FIG. 9 is a flowchart for describing an example of a control method according to a fourth embodiment of the present disclosure.

### DETAILED DESCRIPTION OF THE INVENTION

### First Embodiment

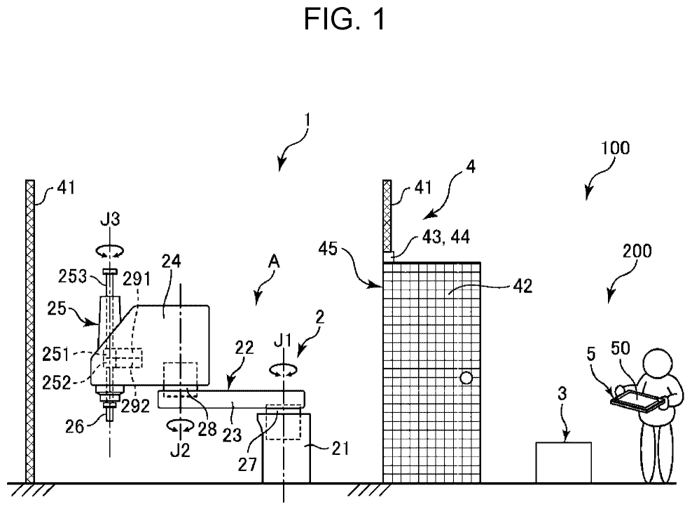

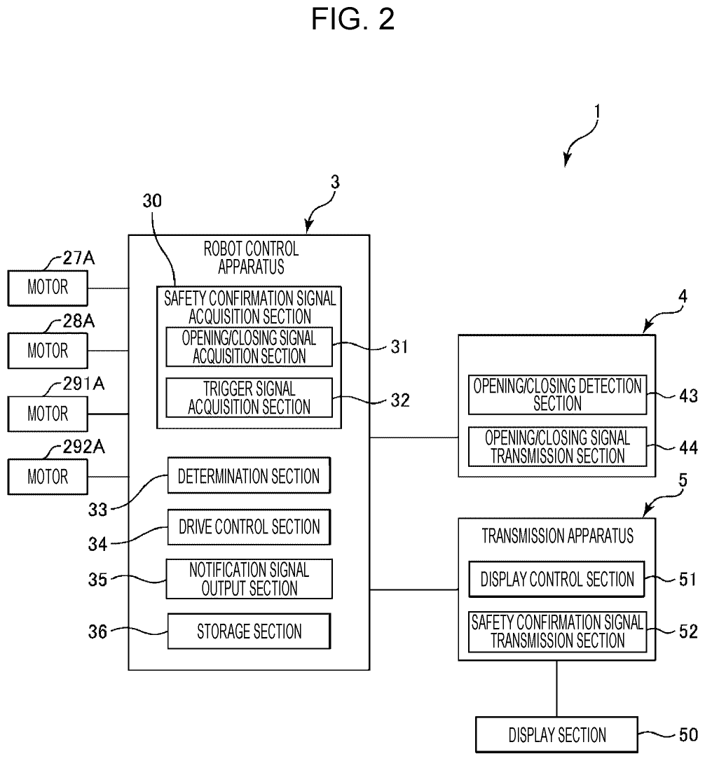

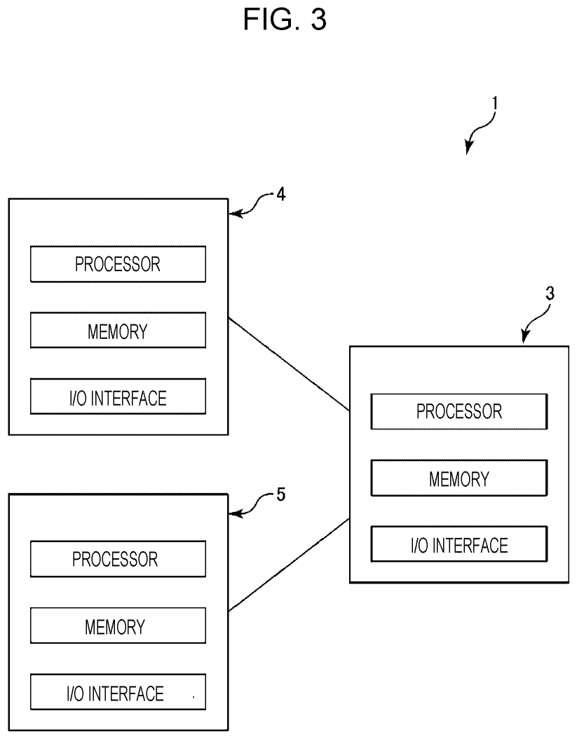

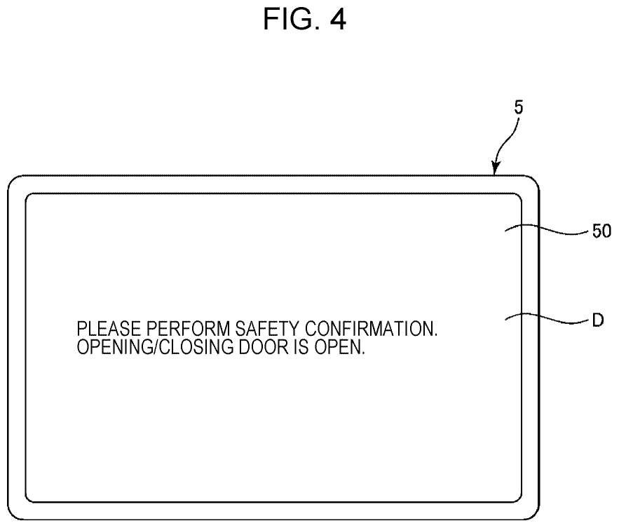

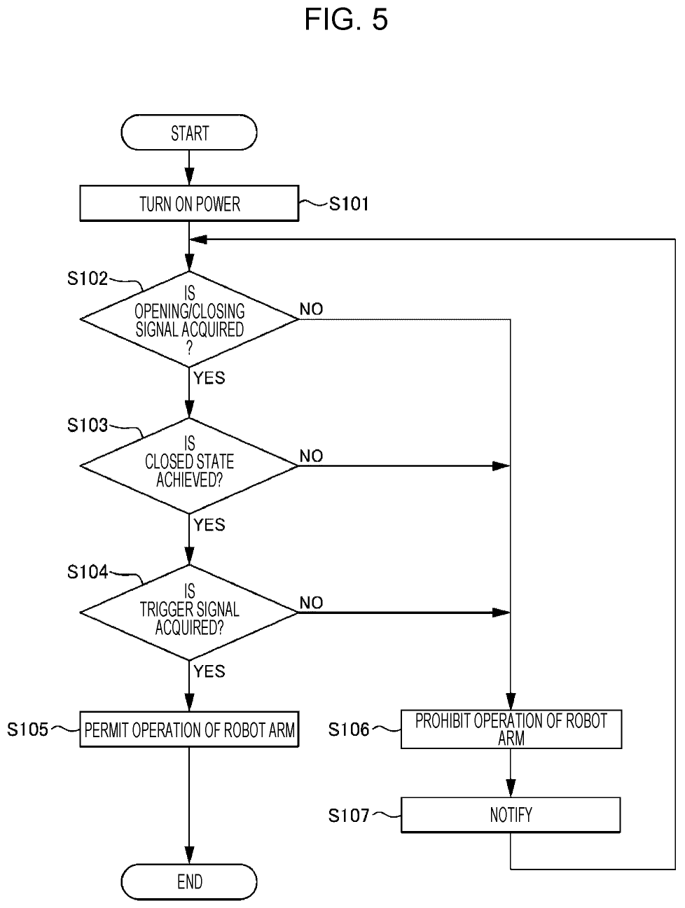

FIG. 1 is a schematic configuration diagram of a robot system including a control system according to a first embodiment of the present disclosure. FIG. 2 is a block diagram of the robot system illustrated in FIG. 1. FIG. 3 is a block diagram illustrating a hardware configuration example of the robot system illustrated in FIG. 1. FIG. 4 is a plan view of a display section (notification section) included in the transmission apparatus illustrated in FIG. 1, and is a view illustrating a state where a notification screen is displayed. FIG. 5 is a flowchart for describing an example of a control method according to the first embodiment of the present disclosure.

Hereinafter, a control system, a robot control apparatus, and a control method of the present disclosure will be described in detail based on preferred embodiments illustrated in the accompanying drawings.

In the following, for convenience of description, regarding the robot arm, a side of a base 21 in FIG. 1 is referred to as a “base end”, and the opposite side, that is, an end effector 26 side is referred to as a “tip end”.

As illustrated in FIG. 1, the robot system 1 is a system that executes a control method of the present disclosure, and includes a robot 2, a robot control apparatus 3 which is an example of the robot control apparatus of the present disclosure, a safety fence system 4, and a transmission apparatus 5. A robot control system 100 is configured by the robot control apparatus 3 and the safety fence system 4. Further, a control system 200, which is an example of the control system of the present disclosure, is configured by the robot control apparatus 3 and the transmission apparatus 5.

First, the robot 2 will be described.

As illustrated in FIG. 1, the robot 2 is a SCARA robot, and drives a robot arm 22 in a desired operation, and performs work such as transport, assembly, and inspection of a workpiece such as an electronic component, or various work such as processing and painting on the workpiece by a tool (hereinafter these are collectively referred to as “work”). However, the application of the robot 2 is not particularly limited. In addition, the robot 2 according to the present disclosure may be a robot other than the SCARA robot, for example, a 6-axis multi-joint robot, an orthogonal robot in which a linear slider is combined, a dual-arm robot, or the like.

As illustrated in FIG. 1, the robot 2 includes the base 21 which is a base portion, and the robot arm 22 which is rotatably coupled to the base 21. The base 21 is fixed to a floor surface parallel to a horizontal plane.

The robot arm 22 includes a first arm 23 of which the base end portion is coupled to the base 21 and rotates around a first rotation axis J1 along the vertical direction with respect to the base 21, and a second arm 24 of which the base end portion is coupled to the tip end portion of the first arm 23 and rotates around a second rotation axis J2 along the vertical direction with respect to the first arm 23.

A working head 25 is provided at the tip end portion of the second arm 24. The working head 25 includes a spline nut 251 and a ball screw nut 252 coaxially disposed at the tip end portion of the second arm 24, and a spline shaft 253 inserted into the spline nut 251 and the ball screw nut 252. The spline shaft 253 is rotatable around a third rotation axis J3 along the central axis in the vertical direction with respect to the second arm 24, and is movable up and down along the third rotation axis J3.

The end effector 26 is mounted on the lower end portion of the spline shaft 253. The end effector 26 is detachable, and the end effector 26 suitable for the work is appropriately selected. Examples of the end effector 26 include those that can hold a workpiece or a tool.

The robot 2 includes a first joint actuator 27 that couples the base 21 and the first arm 23 and rotates the first arm 23 around the first rotation axis J1 with respect to the base 21, and a second joint actuator 28 that couples the first arm 23 and the second arm 24 and rotates the second arm 24 around the second rotation axis J2 with respect to the first arm 23.

The robot 2 includes a first driving mechanism 291 that rotates the spline shaft 253 around the third rotation axis J3 by rotating the spline nut 251, and a second driving mechanism 292 that raises and lowers the spline shaft 253 in the direction along the third rotation axis J3 by rotating the ball screw nut 252.

The first joint actuator 27 includes a motor 27A as a first motor, a speed reducer (not illustrated), an encoder, and the like. The second joint actuator 28 includes a motor 28A as a second motor, a speed reducer (not illustrated), an encoder, and the like. The first driving mechanism 291 includes a motor 291A, a speed reducer (not illustrated), an encoder, and the like. The second driving mechanism 292 includes a motor 292A, a speed reducer (not illustrated), an encoder, and the like.

As illustrated in FIG. 2, the motor 27A, the motor 28A, the motor 291A, and the motor 292A are electrically coupled to the robot control apparatus 3 via a motor driver (not illustrated) respectively. The robot control apparatus 3 controls power-on conditions, that is, power-on amount, power-on timing, and the like from a power supply (not illustrated) to each of the motor 27A, the motor 28A, the motor 291A, and the motor 292A via each motor driver. As a result, the operation of the robot arm 22 can be controlled to change each arm to a desired posture.

Each encoder is electrically coupled to the robot control apparatus 3. Each encoder detects the rotation position information of the corresponding motor and transmits the rotation position information to the robot control apparatus 3. The robot control apparatus 3 controls the power-on conditions to the motor 27A, the motor 28A, the motor 291A, and the motor 292A based on the rotation position information of each motor received from each encoder. By recognizing the rotation positions of each of the motor 27A, the motor 28A, the motor 291A, and the motor 292A, a desired operation can be accurately performed by controlling the operation of the robot arm 22.

Next, the safety fence system 4 will be described.

As illustrated in FIGS. 1 and 2, the safety fence system 4 includes a safety fence 41, an opening/closing door 42, an opening/closing detection section 43, and an opening/closing signal transmission section 44.

The safety fence 41 is provided around the robot 2 to surround a movable region A of the robot 2. As a result, other objects such as a person or an obstacle can be prevented from unintentionally entering the movable region A or approaching the robot 2 during the operation of the robot 2, and thus the safety can be ensured. The movable region A of the robot 2 is a space including a space in which the robot 2, particularly, the robot arm 22 can move and the periphery of the space. The movable region A varies depending on the type of the robot 2.

A part of the safety fence 41 is configured with an opening through which an operator or the like can enter and exit, and an access section 45 for accessing the movable region A of the robot 2 is provided. The access section 45 is provided with an opening/closing door 42 as an opening/closing section that opens or closes the access section 45. When the opening/closing door 42 is in the fully open state (hereinafter referred to as the “open state”), the operator can enter the inside of the safety fence 41 via the access section 45 and can perform work such as installation, replacement, and removal of the work object (workpiece) by the robot 2, and maintenance of the robot 2. Meanwhile, when the opening/closing door 42 is in the fully closed state (hereinafter referred to as the “closed state”), the operator or the like can be prevented from entering and exiting via the access section 45. The opening/closing door 42 is in the open state when the opening/closing door 42 is in a state other than the completely closed state (fully closed state), for example, in a half-open state.

The opening/closing detection section 43 is provided in the vicinity of the opening/closing door 42 and detects the open state or the closed state of the opening/closing door 42. The opening/closing detection section 43 generates information on the detected open state or closed state, that is, information on the open/closed state, and outputs the information to the opening/closing signal transmission section 44.

The detection method of the opening/closing detection section 43 is not particularly limited, and examples thereof include an optical type, a contact type, a capacitance type, and the like.

The opening/closing signal transmission section 44 converts the information on the open/closed state output by the opening/closing detection section 43 into an electric signal and transmits the electric signal to the robot control apparatus 3. Hereinafter the signal including the information on the open/closed state transmitted by the opening/closing signal transmission section 44 is referred to as an opening/closing signal. That is, the opening/closing signal includes information on the open state or the closed state of the opening/closing door 42. Here, the opening/closing signal is not particularly limited, and may be, for example, an electric signal having a voltage value that differs between a case where the opening/closing door 42 is in the closed state and a case where the opening/closing door 42 is in the open state. In this case, the opening/closing signal transmission section 44 and the robot control apparatus 3 are electrically coupled to each other, and the voltage value of the electric signal transmitted from the opening/closing signal transmission section 44 to the robot control apparatus 3 can be monitored to determine whether the opening/closing door 42 is in the open state or the closed state.

In such a safety fence system 4, the robot 2 may be operated when the opening/closing door 42 is in the closed state from the viewpoint of improving safety.

As illustrated in FIGS. 1 and 2, the transmission apparatus 5 is an apparatus that transmits a trigger signal indicating that the operator confirmed safety to the robot control apparatus 3. When the operator visually confirms or touches the opening/closing door 42 by hand or the like to confirm that the opening/closing door 42 is in the closed state (hereinafter referred to as “safety confirmation”), the operator inputs the fact that the safety confirmation is completed to the transmission apparatus 5, and the transmission apparatus 5 transmits a trigger signal to the robot control apparatus 3.

The transmission apparatus 5 includes a display section 50, and a display control section 51 and a trigger signal transmission section 52 as functional sections. In the present embodiment, the transmission apparatus 5 is a tablet terminal that is an apparatus having the display section 50. However, the present disclosure is not limited to this configuration, and the transmission apparatus 5 may be a notebook personal computer, a desktop personal computer, a teaching pendant, a smartphone, or the like, or may be built in any of these. Further, as will be described later, the transmission apparatus 5 only needs to be able to receive an input indicating that the operator performed safety confirmation, and may be a button that does not include the display section 50.

The display section 50 is a display configured with a touch panel. The operator can perform an input operation of various information such as safety confirmation described later and a transmission instruction operation of a trigger signal by viewing an image displayed on the display section 50 or performing a desired touch operation with his or her own finger or a touch pen.

Although not illustrated, the display section 50 displays a safety confirmation input screen in which the operator inputs that the safety confirmation is performed. For example, a safety confirmation completion button (not illustrated) is displayed on the safety confirmation input screen, and the operator inputs that the safety confirmation is completed by pressing the safety confirmation completion button. The safety confirmation performed by the operator is to be confirmed by, for example, visually confirming that the opening/closing door 42 is in the closed state or to be confirmed by touching the opening/closing door 42 by hand (hereinafter referred to as “visually confirming”) when starting the operation of the robot 2.

The display section 50 is configured by, for example, a display panel in which a liquid crystal element, an organic EL element, or the like is arranged in a planar shape, and has, in addition to a display function of information, for example, a touch operation function (input function). The display section 50 can display a display screen and an operation screen in color or monochrome, respectively. In addition, as the type of the touch panel in the display section 50, either a pressure-sensitive type or a capacitance type may be used.

The display control section 51 controls the operation of the display section 50 to display a screen displayed on the display section 50, for example, a safety confirmation input screen or the like. As will be described later, the display control section 51 controls the operation of the display section 50 to display a notification screen D on the display section 50 based on the notification signal output by a notification signal output section 35. That is, the display section 50 functions as a notification section that performs notification based on the notification signal output by the notification signal output section 35.

The trigger signal transmission section 52 acquires a signal indicating that the safety confirmation is performed, that is, a trigger signal, which is input from the safety confirmation input screen, and transmits the trigger signal to the robot control apparatus 3. The transmission of the trigger signal may be automatically performed after the input on the trigger signal input screen, or may be performed by the operator performing a transmission instruction operation of the trigger signal on the display section 50.

As illustrated in FIG. 1, the robot control apparatus 3 is installed outside the safety fence 41. However, the configuration is not limited to this, and the robot control apparatus 3 may be installed inside the safety fence 41.

As illustrated in FIG. 2, the robot control apparatus 3 has a safety confirmation signal acquisition section 30, a determination section 33, a drive control section 34, a notification signal output section 35, and a storage section 36 as functional sections.

The robot control apparatus 3 is provided with a power switch (not illustrated), which is turned on and off by an operator. In a state where the power switch is ON, power is supplied from the external power supply to the robot control apparatus 3, power can be supplied to each section of the robot 2, and a drive signal can be output to the robot 2. Meanwhile, in a state where the power switch is OFF, power is not supplied from the external power supply to each section of the robot control apparatus 3 and the robot 2, and the robot control apparatus 3 cannot operate the robot 2.

The safety confirmation signal acquisition section 30 has an opening/closing signal acquisition section 31 and a trigger signal acquisition section 32.

The opening/closing signal acquisition section 31 acquires the opening/closing signal transmitted by the opening/closing signal transmission section 44 of the safety fence system 4 and stores the opening/closing signal in the storage section 36.

The trigger signal acquisition section 32 acquires the trigger signal transmitted by the trigger signal transmission section 52. The information on the trigger signal acquired by the trigger signal acquisition section 32 is stored in the storage section 36.

In the present embodiment, the expression “the safety confirmation signal acquisition section 30 acquired the safety confirmation signal” means that the opening/closing signal acquisition section 31 acquired the opening/closing signal indicating the closed state and the trigger signal acquisition section 32 acquired the trigger signal. That is, the safety confirmation signal includes both the opening/closing signal indicating the closed state and the trigger signal. In this case, the notification signal output section 35 generates a notification signal in accordance with the opening/closing signal acquired by the opening/closing signal acquisition section 31 and the trigger signal acquired by the trigger signal acquisition section 32.

Unlike the present embodiment, the expression “the safety confirmation signal acquisition section 30 acquired the safety confirmation signal” is also applicable when one of the opening/closing signal and the trigger signal is acquired.

For example, when the opening/closing signal acquisition section 31 is omitted, particularly, when the safety fence system 4 is omitted, the expression “the safety confirmation signal acquisition section 30 acquired the safety confirmation signal” means that the trigger signal acquisition section 32 acquired the trigger signal. In this case, the notification signal output section 35 generates a notification signal in accordance with the trigger signal acquired by the trigger signal acquisition section 32.

In addition, when the trigger signal acquisition section 32 is omitted, the expression “the safety confirmation signal acquisition section 30 acquired the safety confirmation signal” means that the opening/closing signal acquisition section 31 acquired the opening/closing signal indicating the closed state. In this case, the notification signal output section 35 generates a notification signal in accordance with the opening/closing signal acquired by the opening/closing signal acquisition section 31.

The determination section 33 determines whether or not the safety confirmation state is achieved when the power is supplied to the robot control apparatus 3, that is, when the power switch (not illustrated) of the robot control apparatus 3 is turned on. The safety confirmation state is a state where the following conditions (1) and (2) are satisfied.
Condition (1): The opening/closing detection section 43 detects that the closed state is achieved based on the opening/closing signal acquired by the opening/closing signal acquisition section 31. The fact that the condition (1) is satisfied means that the opening/closing detection section 43 detects that the opening/closing door 42 is in the closed state.

In addition, in the determination of the condition (1), the configuration is not limited to the above configuration, and for example, the robot control apparatus 3 may determine that the opening/closing door 42 is in the closed state based on the opening/closing signal acquired by the opening/closing signal acquisition section 31.
Condition (2): The trigger signal acquisition section 32 acquired the trigger signal. The fact that the condition (2) is satisfied means that the operator, for example, visually confirms that the opening/closing door 42 is in the closed state, inputs the fact, and transmits the fact.

The determination section 33 determines that the “safety confirmation state” is achieved when both the conditions (1) and (2) are satisfied, and determines that the “safety unconfirmed state” is achieved when at least one of the conditions (1) and (2) is not satisfied.

The determination result of the determination section 33 is transmitted to the drive control section 34. That is, the information on whether the safety confirmation state or the safety unconfirmed state is achieved is transmitted to the drive control section 34.

Supplying power to the robot control apparatus 3 includes switching from an OFF state to an ON state of the power supply and switching the robot control apparatus 3 from a sleep state (low power state) to a normal startup state.

The drive control section 34 permits the operation of the robot arm 22 when the determination section 33 determines that the safety confirmation state is achieved. That is, in a case where the determination section 33 determines that the safety confirmation state is achieved, the drive control section 34 reads out and executes various operation programs stored in the storage section 36, for example, when the drive control section 34 receives an operation start instruction by a touch operation on the display section 50 by the operator. The drive signal generated by the drive control section 34 is transmitted to each section of the robot 2. As a result, the robot arm 22 can safely execute a predetermined operation (work) under predetermined conditions.

Meanwhile, the drive control section 34 prohibits the operation of the robot arm 22 when the determination section 33 determines that the safety confirmation state is not achieved, that is, the safety unconfirmed state is achieved. In other words, when the determination section 33 determines that the safety confirmation state is not achieved, the drive control section 34 does not transmit the drive signal to each section of the robot 2 regardless of the presence or absence of the operation start instruction by the operator, and does not operate the robot 2.

As described above, when the power switch is turned on, the robot control apparatus 3 permits the operation of the robot arm 22 only when both the conditions (1) and (2) are satisfied. In other words, the operation of the robot arm 22 is permitted only when the opening/closing detection section 43 detects that the opening/closing door 42 is in the closed state and the operator, for example, visually confirms that the opening/closing door 42 is in the closed state, that is, when the double check is completed. As a result, erroneous recognition of the open/closed state caused by human error (for example, erroneous recognition due to the operator's mistake), machine error (for example, malfunction or failure of the opening/closing detection section 43), or system error (for example, malfunction or failure of the opening/closing signal acquisition section 31 or the opening/closing signal transmission section 44) can be effectively prevented, and the robot arm 22 can be operated with high safety.

When the determination section 33 determines that the safety confirmation state is not achieved (safety unconfirmed state), the notification signal output section 35 generates and outputs a notification signal for notifying that safety confirmation is required. The notification signal output by the notification signal output section 35 is transmitted to the transmission apparatus 5.

The notification signal is a signal for notifying that safety confirmation is required until the safety confirmation signal acquisition section 30 acquires the safety confirmation signal. In the present embodiment, the notification signal is a signal for notifying that safety confirmation is required until the opening/closing signal acquisition section 31 acquires an opening/closing signal indicating a closed state and the trigger signal acquisition section 32 acquires a trigger signal.

As illustrated in FIG. 4, the notification screen D displayed on the display section 50 displays the character string “Please perform safety confirmation. The opening/closing door is open.”. By viewing this sentence, the operator can recognize that the safety unconfirmed state is achieved, and can set the opening/closing door 42 to the closed state or transmit the trigger signal. That is, the operator can be notified (urged) that the safety unconfirmed state is achieved, and the safety confirmation can be prompted.

Further, the display section 50 notifies that the safety confirmation state is not achieved (safety unconfirmed state) together with the cause of the safety confirmation state not being achieved (the opening/closing door 42 is in the open state). For example, the notification screen D including the character string “The trigger signal cannot be received” or the character string of “Confirm that the opening/closing door is closed and transmit the trigger signal” is displayed on the display section 50. As a result, the operator can recognize that the safety confirmation state is not achieved and the cause thereof, and can appropriately and quickly take measures to eliminate the cause.

The configuration is not limited to the above configuration, and the display section 50 may be configured to omit the notification of the cause of the safety confirmation state not being achieved and to notify only that the safety confirmation state is not achieved (the safety unconfirmed state is achieved).

The notification screen D is displayed in a case where the safety unconfirmed state is achieved when the power switch is turned on. The display may be configured to be displayed even when the safety unconfirmed state is achieved during the operation of the robot arm 22.

When the operator performs the safety confirmation after viewing the notification screen D, and then transmits the trigger signal, the notification is stopped, and the robot control apparatus 3 permits the operation of the robot arm 22. As a result, the robot arm 22 can be operated safely.

In the present embodiment, a case is described where a notification is performed using the display section 50, that is, a visual notification is performed, however, the present disclosure is not limited to this and may be configured to perform an auditory notification or a tactile notification. That is, when the transmission apparatus 5 has a sound emitting function (a function of emitting voice, a warning sound, or the like), the notification signal output section 35 generates a notification signal for operating a sound emitting section, and when the transmission apparatus 5 has a vibration function, the notification signal output section 35 generates a notification signal for operating the vibration. In this case, the transmission apparatus 5 may be configured to include a speaker for realizing a sound emitting function or a motor for realizing a vibration function.

In addition, the notification signal output section 35 may be configured to generate a notification signal for performing notification by combining two or more of visual notification, auditory notification, and tactile notification.

The notification screen D is displayed when the safety unconfirmed state is achieved after a predetermined time (for example, about one minute) elapses since the power was supplied to the robot control apparatus 3. That is, the notification signal output section 35 outputs the notification signal after a predetermined time elapses since the power is supplied to the robot control apparatus 3. Here, the predetermined time to be set is preferably set in the range of about 30 seconds to 3 minutes after the power is supplied and system startup is completed, taking into account the time from when the operator performs the safety confirmation until when the trigger signal is transmitted. As a result, the notification that safety confirmation is required can be prevented or suppressed when the operator is trying to turn on the power supply of the robot control apparatus 3 to perform the safety confirmation, and the usability can be improved. That is, the safety unconfirmed state can be effectively notified to the operator.

When the power is supplied to the robot control apparatus 3 and the safety unconfirmed state is achieved, the notification signal output section 35 may immediately output the notification signal. In addition, in this case, the display section 50 may immediately display the notification screen D, or may display the notification screen D after a predetermined time elapses.

Further, the notification signal output section 35 generates a notification signal in which the degree or method of notification is changed such that the notification effect is enhanced as the time elapses from when the notification signal is output until when the safety confirmation signal is acquired.

The expression “level of notification is changed to enhance the notification effect” may be achieved by a visual, auditory, or tactile approach, and one or two or more of these may be combined.

### Visual Approaches

The visual approach includes changing the color of the characters on the notification screen D, making the characters on the notification screen D larger, changing the light emission pattern of the characters on the notification screen D, and displaying additional characters on the notification screen D. The notification can be made by combining one or two or more of these.

In addition, when the notification section (display section 50) is configured with, for example, a plurality of light emitting elements such as LED, the configuration is exemplified in which the notification effect is enhanced by increasing the brightness of the light emitting element, the number of light emitting elements on, and the like.

### Tactile Approaches

When the transmission apparatus 5 has a vibration function, the vibration pattern can be changed, the vibration intensity can be increased, or one or both of these can be notified in combination.

### Auditory Approaches

When the transmission apparatus 5 has a sound emitting function, a sound pattern can be changed, a sound quality can be changed, a sound volume can be increased, and the like, and one or two or more of these can be notified in combination.

When two or more types of visual, auditory, and tactile notification are combined, the notification effect may be enhanced in each type, or the notification effect may be enhanced by fixing one type and using the other type.

In addition, in any of the cases of visual notification, auditory notification, and tactile notification, the notification effect may be continuously enhanced as the time elapses, or the notification effect may be enhanced stepwise.

Further, the robot control apparatus 3 may transmit the notification signal to a designated smartphone, that is, the smartphone (mobile phone) possessed by the operator, and may also perform the notification on the smartphone. As a result, even when the operator is in a place away from the robot 2 with the transmission apparatus 5 different from the smartphone left behind, notification can be performed to prompt the operator to perform the safety confirmation. More specifically, a configuration may be adopted in which a notification signal is transmitted to the designated smartphone as a communication destination by using a network communication unit (not illustrated).

In this case, the robot control apparatus 3 may be registered in advance with the smartphone of the operator, that is, the individual information of the smartphone of the operator may be stored. As a result, the above-mentioned notification can be smoothly performed.

The notification by the transmission apparatus 5 and the notification by the smartphone may be the same or different unit.

In addition, when a smartphone is used as the transmission apparatus 5, a configuration may be adopted in which a notification signal is transmitted to the smartphone to perform notification.

The storage section 36 stores a program or the like for executing the control operation performed by each of the above-described functional sections.

Each functional section of the robot control apparatus 3, the safety fence system 4, and the transmission apparatus 5 can be realized by a hardware configuration example as illustrated in FIG. 3. The robot control apparatus 3, the safety fence system 4, and the transmission apparatus 5 each include at least one processor, a memory, and an I/O interface. The control section, the storage section, and the communication section are coupled to each other to be able to communicate with each other, for example, via a bus.

Here, the safety fence system 4 may be configured to be able to transmit a signal indicating the open state or the closed state of the opening/closing door 42, and may be configured to include a physical switch that is electrically coupled to the robot control apparatus 3 without including a processor, for example.

The processor is configured with, for example, a central processing unit (CPU), and reads out and executes various programs stored in the memory. The processor is an example of the control section.

The memory stores various programs executed by the processor and the like. Examples of the memory include a configuration having a volatile memory such as a random access memory (RAM), a non-volatile memory such as a read only memory (ROM), a detachable external storage device, and the like. The memory is an example of a storage section. In addition, the storage section is not limited to this configuration, and may be mounted by a relay circuit that is switched according to the state.

The I/O interface corresponds to a communication unit such as a wired local area network (LAN) or a wireless LAN. As a result, signals can be transmitted and received between the robot control apparatus 3, the safety fence system 4, and the transmission apparatus 5, or between the robot control apparatus 3, the safety fence system 4, and the transmission apparatus 5, and the external devices. The transmission and reception of the signal may be performed via a server (not illustrated), or may be performed via a network communication unit such as the Internet. The I/O interface is an example of a communication section.

As described above, the control system 200 includes the robot control apparatus 3 that controls the operation of the robot 2 having the robot arm 22, and the transmission apparatus 5 that transmits the safety confirmation signal indicating that it is confirmed that the robot 2 can be safely operated to the robot control apparatus 3. Further, the robot control apparatus 3 includes the safety confirmation signal acquisition section 30 that acquires a safety confirmation signal, and the notification signal output section 35 that generates and outputs a notification signal for notifying that safety confirmation is required until the safety confirmation signal acquisition section 30 acquires the safety confirmation signal when the power is supplied to the robot control apparatus 3. As a result, when the safety confirmation state is not achieved, that is, when the safety unconfirmed state is achieved, the operator can be notified (urged) that the safety unconfirmed state is achieved, and the safety confirmation can be prompted. Therefore, the robot arm 22 can be operated quickly and safely. As a result, work efficiency of the robot can be improved, and productivity can be improved.

In addition, the robot control apparatus 3 controls the operation of the robot 2 having the robot arm 22, and includes the safety confirmation signal acquisition section 30 that acquires the safety confirmation signal indicating that it is confirmed that the robot 2 can be operated safely, and the notification signal output section 35 that generates and outputs the notification signal for notifying that safety confirmation is required until the safety confirmation signal acquisition section 30 acquires the safety confirmation signal when the power is supplied to the robot control apparatus 3. As a result, when the safety confirmation state is not achieved, that is, when the safety unconfirmed state is achieved, the operator can be notified (urged) that the safety unconfirmed state is achieved, and the safety confirmation can be prompted. Therefore, the robot arm 22 can be operated quickly and safely. As a result, work efficiency of the robot can be improved, and productivity can be improved.

Although the case where the display section 50 is provided in the transmission apparatus 5 as the notification section that operates by the notification signal was described, the present disclosure is not limited thereto, and the notification section may be provided in the robot control apparatus 3.

The notification signal output section 35 outputs a notification signal after a predetermined time elapses since the power is supplied to the robot control apparatus 3. As a result, usability can be improved. That is, the safety unconfirmed state can be effectively notified to the operator.

The notification signal output section 35 may output the notification signal immediately after the power is supplied to the robot control apparatus 3.

The notification signal output section 35 generates a notification signal in which the degree or method of notification is changed such that the notification effect is enhanced as the time elapses from when the notification signal is output until when the safety confirmation signal is acquired. As a result, the safety unconfirmed state can be more reliably and effectively notified to the operator.

The robot control apparatus 3 transmits a notification signal to the designated smartphone. As a result, the operator can be more reliably notified.

The robot control apparatus 3 may be configured to transmit the notification signal to a device other than the smartphone, for example, a smart watch, a head mount display, or the like.

Further, as described above, the safety confirmation signal acquisition section 30 includes the opening/closing signal acquisition section 31 that acquires the opening/closing signal including the information on the open/closed state detected by the opening/closing detection section 43 that detects an open state or a closed state of the opening/closing door 42 as an opening/closing section that opens or closes the access section 45 that is configured to access the movable region A of the robot 2, and the notification signal output section 35 generates the notification signal in accordance with the opening/closing signal acquired by the opening/closing signal acquisition section 31. As a result, the open/closed state detected by the opening/closing detection section 43 can be notified.

Further, as described above, the safety confirmation signal acquisition section 30 includes the trigger signal acquisition section 32 that acquires the trigger signal, and the notification signal output section 35 generates the notification signal in accordance with the trigger signal acquired by the trigger signal acquisition section 32. As a result, the open/closed state detected by the opening/closing detection section 43 can be notified.

The safety confirmation signal acquisition section 30 includes: the opening/closing signal acquisition section 31 that acquires the opening/closing signal including information on the open/closed state detected by the opening/closing detection section 43 that detects the open state or the closed state of the opening/closing door 42 as an opening/closing section that opens or closes the access section 45 that is configured to access the movable region A of the robot 2; and the trigger signal acquisition section 32 that acquires the trigger signal, the robot control apparatus 3 includes the determination section 33 that defines, as a safety confirmation state, a case where, when power is supplied to the robot control apparatus 3, the opening/closing detection section 43 detects that the closed state is achieved based on the opening/closing signal acquired by the opening/closing signal acquisition section 31, and the trigger signal acquisition section 32 acquires the trigger signal, and determines whether or not the safety confirmation state is achieved, and the robot control apparatus 3 permits the operation of the robot arm 22 when the determination section 33 determines that the safety confirmation state is achieved, and prohibits the operation of the robot arm 22 until the safety confirmation signal acquisition section 30 acquires the safety confirmation signal and generates and outputs the notification signal by the notification signal output section 35 when the determination section 33 determines that the safety confirmation state is not achieved. Accordingly, the robot arm 22 can be configured to be permitted to operate only when confirmation of the closed state of the opening/closing door 42 is completed both via the opening/closing signal acquisition section 31 and via the trigger signal acquisition section 32. Therefore, erroneous recognition of the open/closed state caused by human error, machine error, or system error can be effectively prevented, and the robot arm 22 can be operated with high safety.

In the present embodiment, a case where the trigger signal is the safety confirmation signal input by the operator using the transmission apparatus 5 is described as an example, but the present disclosure is not limited thereto, and the trigger signal may be a signal (a signal indicating that the entering object is absent) output by the entering object detection sensor 6 described in a third embodiment to be described later.

In the present embodiment, a configuration in which the drive control section 34 permits or prohibits the operation of the robot arm 22 is described, but the present disclosure is not limited thereto, and a configuration in which a functional section other than the drive control section 34 permits or prohibits the operation of the robot arm 22 by switching the supply and interruption of power to the robot 2 may be adopted.

Next, an example of the control method of the present disclosure will be described with reference to the flowchart illustrated in FIG. 5.

First, in step S101, the power supply is turned on. That is, the power switch (not illustrated) is turned on to supply power from the external power supply to the robot control apparatus 3.

Next, in step S102, it is determined whether or not the opening/closing signal is acquired. That is, the opening/closing signal acquisition section 31 determines whether or not the opening/closing signal is acquired. In step S102, when it is determined that the opening/closing signal is acquired (step S102: YES), the process proceeds to step S103, and when it is determined that the opening/closing signal is not acquired in step S102 (step S102: NO), the process proceeds to step S106.

In step S103, it is determined whether or not the closed state is achieved. That is, it is determined whether or not the acquired opening/closing signal includes the information on the closed state. In step S103, when it is determined that the closed state is achieved (step S103: YES), the process proceeds to step S104, and when it is determined that the closed state is not achieved in step S103 (step S103: NO), the process proceeds to step S106.

In step S104, it is determined whether or not the trigger signal is acquired. That is, the opening/closing signal acquisition section 31 acquires the opening/closing signal indicating the closed state, and the trigger signal acquisition section 32 determines whether or not the trigger signal is acquired. In step S104, when it is determined that the trigger signal is acquired (step S104: YES), the process proceeds to step S105, and when it is determined that the trigger signal is not acquired in step S104 (step S104: NO), the process proceeds to step S106.

Such steps S102, S103, and S104 are a first step of determining whether or not the safety confirmation state is achieved. Steps S102, S103, and S104 are executed by the determination section 33. When the results in all of steps S102, S103, and S104 are YES, it is determined that the safety confirmation state is achieved (the safety confirmation signal acquisition section 30 acquires the safety confirmation signal), and in step S105, the operation of the robot arm 22 is permitted.

Meanwhile, when the results in one or more of step S102, step S103, and step S104 are NO, the operation of the robot arm 22 is prohibited in step S106.

After step S106, in step S107, notification is performed by the notification section (display section 50). That is, the safety confirmation signal acquisition section 30 generates and outputs a notification signal for notifying that safety confirmation is required until the safety confirmation signal acquisition section 30 acquires the safety confirmation signal. Then, the display section 50 performs notification based on the notification signal (refer to FIG. 4). As a result, the operator can be notified (urged) that the safety confirmation state is not achieved, that is, that the safety unconfirmed state is achieved, and the safety confirmation can be prompted. Such step S107 is the first step.

After step S107 is executed, the process returns to step S102, and the subsequent steps are sequentially executed. In step S104 in the second and subsequent cycles, when it is determined that the safety confirmation signal is acquired, in step S105, the output of the notification signal is stopped, and the operation of the robot arm 22 is permitted. Step S105 in the second and subsequent cycles is the second step.

Although not illustrated, after step S105, in step S107, a notification that the safety confirmation state is achieved may be performed.

As described above, the control method according to the present disclosure is a control method of the robot control apparatus 3 that controls the operation of the robot 2 and includes the safety confirmation signal acquisition section 30 that acquires a safety confirmation signal indicating that it is confirmed that the robot 2 having the robot arm 22 is configured to be operated safely, the control method including: a first step of generating and outputting a notification signal for notifying that safety confirmation is required until the safety confirmation signal acquisition section 30 acquires the safety confirmation signal when power is supplied to the robot control apparatus 3; and a second step of stopping the output of the notification signal and permitting the operation of the robot arm 22 when acquiring the safety confirmation signal. As a result, when the safety confirmation state is not achieved, that is, when the safety unconfirmed state is achieved, the operator can be notified (urged) that the safety unconfirmed state is achieved, and the safety confirmation can be prompted. Therefore, the robot arm 22 can be operated quickly and safely. As a result, work efficiency of the robot can be improved, and productivity can be improved.

The present disclosure is not limited to the configuration in which step S102, step S103, and step S104 are executed in this order, and for example, step S104, step S102, and step S103 may be executed in this order.

### Second Embodiment

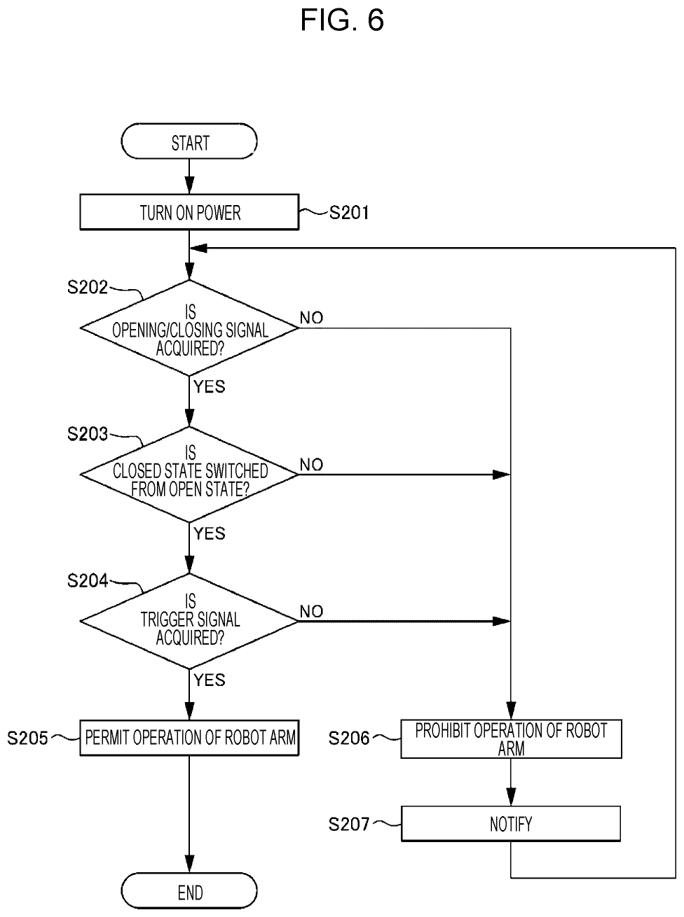

FIG. 6 is a flowchart for describing an example of the control method according to a second embodiment of the present disclosure.

Hereinafter, the control system, the robot control apparatus, and the control method according to the second embodiment of the present disclosure will be described with reference to FIG. 6. In the following, mainly differences from the first embodiment will be described, and description of common points will be omitted.

In the present embodiment, the determination section 33 determines whether or not the safety confirmation state is achieved by determining whether or not the following conditions (1A) and (2) are satisfied when the power is supplied to the robot control apparatus 3.
Condition (1A): The opening/closing detection section 43 detects that the open state is changed to the closed state based on the opening/closing signal acquired by the opening/closing signal acquisition section 31. The fact that the condition (1A) is satisfied means that the opening/closing signal includes information that the open state is switched to the closed state. When the condition (1A) is satisfied, it is confirmed that the opening/closing door 42 is switched from the open state to the closed state, and it can be considered that the operator performs the work of closing the opening/closing door 42.
Condition (2): The trigger signal acquisition section 32 acquired the trigger signal. The fact that the condition (2) is satisfied means that the operator, for example, visually confirms that the opening/closing door 42 is in the closed state, inputs the fact, and transmits the fact. The condition (2) is the same as that of the first embodiment.

The determination section 33 determines that the “safety confirmation state” is achieved when both the conditions (1A) and (2) are satisfied, and determines that the “safety unconfirmed state” is achieved when at least one of the conditions (1A) and (2) is not satisfied.

According to the condition (1A), when the power is supplied to the robot control apparatus 3 and the opening/closing door 42 is in the closed state, the operator needs to execute the work of opening and closing the opening/closing door 42 again after opening the opening/closing door 42 once. In executing this work, the operator is prompted to visually confirm the safety in the movable region A of the robot 2. Therefore, the robot arm 22 can be operated with higher safety.

The notification signal output section 35 generates and outputs a notification signal for notifying that safety confirmation is required until the safety confirmation signal acquisition section 30 acquires the safety confirmation signal, that is, until both the condition (1A) and the condition (2) are satisfied. The subsequent control is the same as that of the first embodiment.

As described above, in the present embodiment, a state where it is confirmed that the opening/closing door 42 is switched from the open state to the closed state, and a state where the operator confirms that the opening/closing door 42 is in the closed state by visual confirmation or the like are set as the safety confirmation state. When the determination section 33 determines that the safety confirmation state is achieved, the operation of the robot arm 22 is permitted. Accordingly, the robot arm 22 is configured to be permitted to operate only when confirmation of the closed state is completed both via the opening/closing signal acquisition section 31 and via the trigger signal acquisition section 32. In particular, since it can be confirmed that the opening/closing door 42 is switched from the open state to the closed state, the robot arm 22 can be operated with higher safety.

As illustrated in FIG. 6, the control method of the present embodiment includes steps S201, S202, S203, S204, S205, S206, and S207. Since steps S201, S202, S204, S205, S206, and S207 are the same as steps S101, S102, S104, S105, S106, and S107 in the first embodiment, the description thereof will be omitted, and step S203 will be described.

In step S203, it is determined whether or not the information that the open state is switched to the closed state is included in the opening/closing signal acquired by the opening/closing signal acquisition section 31 in step S202. In step S203, when it is determined that the information that the opening/closing signal is switched from the open state to the closed state is included, the process proceeds to step S204. In step S203, when it is determined that the information that the opening/closing signal is switched from the open state to the closed state is not included, the process proceeds to step S206.

Although not illustrated in FIG. 6, after step S205, in step S207, a notification that the safety confirmation state is achieved may be performed.

As described above, in the robot control system 100, when the robot control apparatus 3 is supplied with power, and the opening/closing door 42 as the opening/closing section is switched from the open state to the closed state, and the opening/closing signal indicating that the opening/closing door 42 as the opening/closing section is switched from the open state to the closed state is received, the determination section 33 determines that the safety confirmation state is achieved. As a result, it can be confirmed that the opening/closing door 42 is switched from the open state to the closed state, and thus the robot arm 22 can be operated with higher safety.

Even when the opening/closing signal indicating the open state and the opening/closing signal indicating the closed state are sequentially received, these two opening/closing signals can be regarded as opening/closing signals indicating that the open state is switched to the closed state.

As described above, in the present embodiment, when the power is supplied to the robot control apparatus 3, and the opening/closing signal indicating that the open state is switched to the closed state is received, the determination section 33 determines that the safety confirmation state is achieved. As a result, the robot arm 22 can be operated with higher safety.

### Third Embodiment

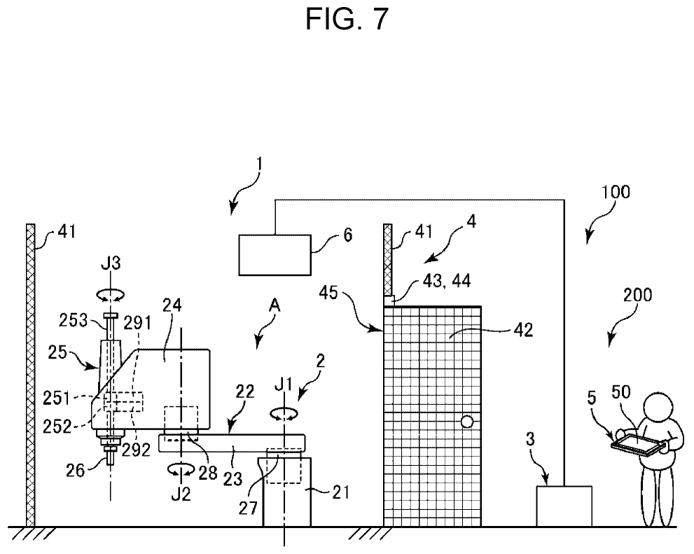

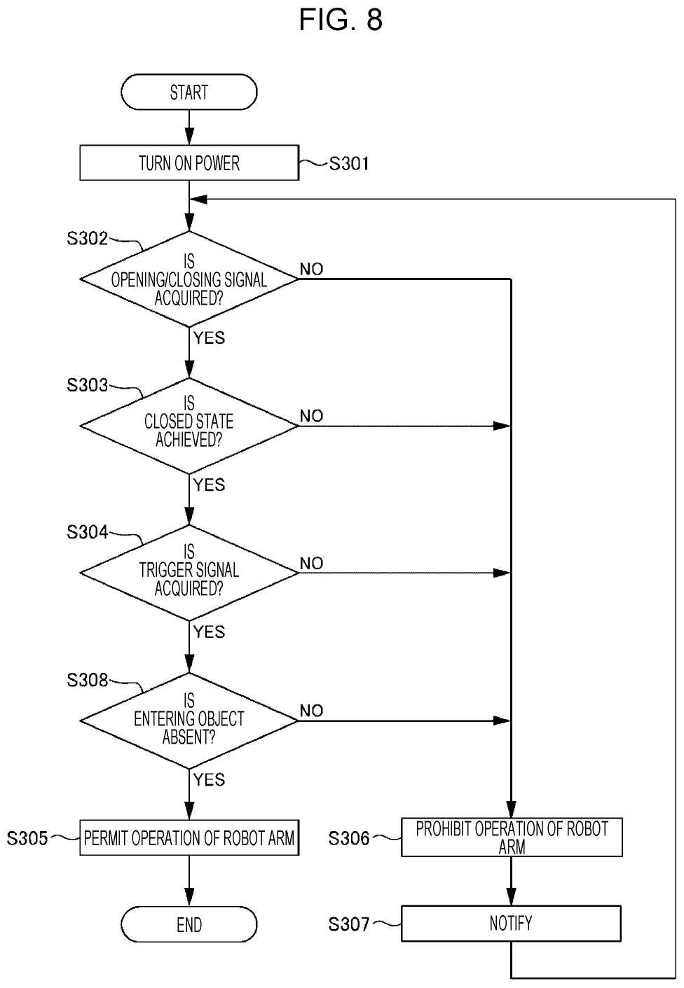

FIG. 7 is a schematic configuration diagram of the robot system including the control system according to the third embodiment of the present disclosure. FIG. 8 is a flowchart for describing an example of the control method according to the third embodiment of the present disclosure.

Hereinafter, the control system, the robot control apparatus, and the control method according to the third embodiment of the present disclosure will be described with reference to FIGS. 7 and 8. In the following, mainly differences from the first embodiment will be described, and description of common points will be omitted.

As illustrated in FIG. 7, the robot system 1 includes the entering object detection sensor 6 that detects the entering object in the movable region A. The entering object detection sensor 6 is configured by, for example, various image recognition devices (cameras), various contact (touch) sensors, various optical sensors, various magnetic sensors, various electrostatic capacitive sensors, or a combination of two or more of these. The entering object detection sensor 6 is electrically coupled to the robot control apparatus 3, and the detection value detected by the entering object detection sensor 6 is transmitted to the robot control apparatus 3 as an electric signal, and is acquired by the trigger signal acquisition section 32.

An electric signal (hereinafter referred to as a “sensor signal”) of a detection value detected by the entering object detection sensor 6 is included in the trigger signal. That is, the trigger signal includes the safety confirmation signal described in the first embodiment and the sensor signal.

The sensor signal may be a signal after the presence or absence of the entering object is determined, or may be a signal before the presence or absence of the entering object is determined. That is, the configuration may be such that the entering object detection sensor 6 determines the presence or absence of the entering object, or the configuration may be such that the robot control apparatus 3 determines the presence or absence of the entering object.

The determination section 33 determines whether or not the safety confirmation state is achieved when the power is supplied to the robot control apparatus 3. The safety confirmation state is a state where the following conditions (1), (2), and (3) are satisfied.
Condition (1): The opening/closing detection section 43 detects that the closed state is achieved based on the opening/closing signal acquired by the opening/closing signal acquisition section 31. This is the same as in the first embodiment.
Condition (2): The trigger signal acquisition section 32 acquired the trigger signal from the transmission apparatus 5. This is the same as in the first embodiment.
Condition (3): The entering object is absent in the determination result of the presence or absence of the entering object based on the sensor signal.

The determination section 33 determines that the “safety confirmation state” is achieved when all of the conditions (1), (2), and (3) are satisfied, and determines that the “safety unconfirmed state” is achieved when at least one of the conditions (1), (2), and (3) is not satisfied.

The notification signal output section 35 generates and outputs a notification signal for notifying that safety confirmation is required until the safety confirmation signal acquisition section 30 acquires the safety confirmation signal, that is, until all of the condition (1), (2), and (3) are satisfied. The subsequent control is the same as that of the first embodiment.

As described above, when the power switch is turned on, the robot control apparatus 3 permits the operation of the robot arm 22 only when all of the conditions (1), (2), and (3) are satisfied. In other words, the operation of the robot arm 22 is permitted only when the opening/closing detection section 43 detects that the opening/closing door 42 is in the closed state, the operator, for example, visually confirms that the opening/closing door 42 is in the closed state, and further confirms that the entering object is absent based on the sensor signal of the entering object detection sensor 6, that is, when the triple check is completed. Accordingly, erroneous recognition of the open/closed state caused by human error, machine error, or system error can be effectively prevented, and the robot arm 22 can be operated with higher safety.

In particular, even when the entering object enters the movable region A suddenly in a state where the conditions (1) and (2) are satisfied, the operation of the robot arm 22 is not permitted, and thus high safety can be ensured.

As described above, the trigger signal is based on the sensor signal, which is a signal transmitted from the entering object detection sensor 6 that detects the entering object entering the movable region A. As a result, the robot arm 22 can be operated after further confirming that the entering object is absent in the movable region A. Therefore, the robot arm 22 can be operated with higher safety.

As illustrated in FIG. 8, the control method of the present embodiment includes steps S301, S302, S303, S304, S305, S306, S307, and S308. Since steps S301, S302, S303, S304, S305, and S306 are the same as steps S101, S102, S103, S104, S105, and S106 in the first embodiment, the description thereof will be omitted, and steps S307 and S308 will be described.

Step S308 is executed by the determination section 33 when it is determined that the trigger signal is acquired in step S304 (S304: YES).

In step S308, the presence or absence of an entering object in the movable region A is determined based on the sensor signal, which is the signal transmitted from the entering object detection sensor 6. In step S308, when it is determined that an entering object is absent, the process proceeds to step S305, and when it is determined that an entering object is present in step S308, the process proceeds to step S306.

As described above, in the control method of the present embodiment, the robot arm 22 can be operated after further confirming that the entering object is absent in the movable region A. Therefore, the robot arm 22 can be operated with higher safety.

After step S306, step S307 is executed. In step S307, the notification section (display section 50) performs notification. The content of the notification is that the safety unconfirmed state is achieved, that is, at least one of the conditions (1), (2), and (3) is not satisfied, and the cause of the content. As in the first embodiment, the cause of the safety unconfirmed state is that the condition (1) is not satisfied, the condition (2) is not satisfied, and the condition (3) is not satisfied, that is, the entering of the entering object into the movable region A.

Step S307 is executed by the notification signal output section 35 and the notification section (display section 50) in the same manner as in the first embodiment.

Further, although not illustrated in FIG. 8, after step S305, in step S307, a notification that the safety confirmation state is achieved may be performed.

In the present embodiment, the detection (confirmation) of the presence or absence of the entering object in the movable region A may be performed at a predetermined time, for example, at any stage of before the operation disclosure of the robot arm 22, at the start of the operation, and during the operation, or may be performed at any time.

In the present embodiment, step S303 may be the same as step S203 of the second embodiment.

### Fourth Embodiment

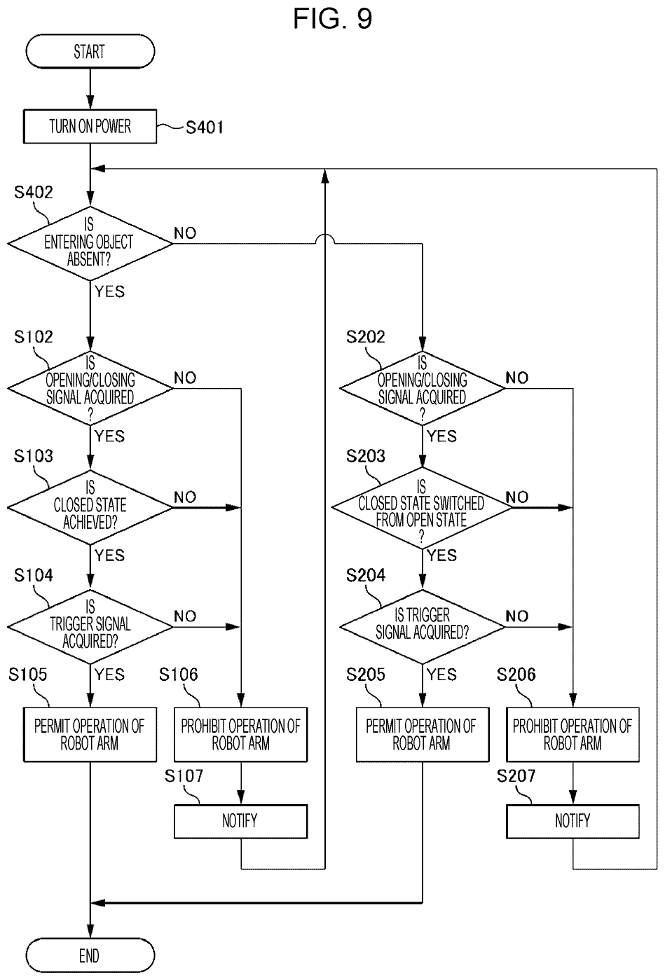

FIG. 9 is a flowchart for describing an example of the control method according to a fourth embodiment of the present disclosure.

Hereinafter, the control system, the robot control apparatus, and the control method according to the fourth embodiment of the present disclosure will be described with reference to FIG. 9. In the following, mainly differences from the first embodiment will be described, and description of common points will be omitted.

The present embodiment has the same system configuration as the third embodiment, and includes the robot 2, the robot control apparatus 3, the safety fence system 4, the transmission apparatus 5, and the entering object detection sensor 6, as illustrated in FIG. 7.

In the present embodiment, the first embodiment is different in that the method of performing the safety confirmation differs depending on the result detected by the entering object detection sensor 6 when the power switch is turned on.

As illustrated in FIG. 9, the control method of the present embodiment includes steps S401, S402, S102, S103, S104, S202, S203, S204, S105, S106, S107, S205, S206, and S207. Since step S401 is the same as step S101 in the first embodiment, the description thereof will be omitted, and step S402 will be described.

In step S402, the presence or absence of an entering object in the movable region A is determined based on the sensor signal, which is the signal transmitted from the entering object detection sensor 6. In step S402, when it is determined that the entering object is absent, the process proceeds to step S102, and then the same control operation as in the first embodiment is executed until the process proceeds to step S105 or step S107. In step S402, when it is determined that the entering object is present, the process proceeds to step S202, and then the same control operation as in the second embodiment is executed until the process proceeds to step S205 or step S207.

In other words, in the present embodiment, when it is determined that the entering object is absent in step S402, the control operation (S102 to S107) of the first embodiment is executed. That is, the operation of the robot arm 22 is permitted only when the conditions (1) and (2) are satisfied. Meanwhile, when it is determined that the entering object is present in step S402, the control operation (S202 to S207) of the second embodiment is executed. That is, the operation of the robot arm 22 is permitted only when the conditions (1A) and (2) are satisfied. By selecting whether to use the conditions (1) and (2) as the determination reference or to use the conditions (1A) and (2) as the determination reference depending on the presence or absence of the entering object, when the entering object is present, the operator can be effectively prompted to visually confirm the safety in the movable region A of the robot 2.

As described above, in the control method of the present embodiment, when an entering object is present in the movable region A, in order to permit the operation of the robot arm, the opening/closing signal needs to satisfy the condition (1A) that the open state is switched to the closed state. Therefore, the robot arm 22 can be operated with higher safety as compared with a case where the entering object is absent in the movable region A. Further, by changing the condition for permitting the operation of the robot arm 22 in accordance with the presence or absence of the entering object in the movable region A, the convenience of the operator can be improved.

Although not illustrated in FIG. 9, after step S105 is executed, a notification that the safety confirmation state is achieved may be performed in step S107.

Above, the control system, the robot control apparatus, and the control method of the present disclosure were described with reference to each of the embodiments illustrated in the drawings, but the present disclosure is not limited thereto. In addition, each section and each step of the control system, the robot control apparatus, and the control method can be replaced with any structure and step that can exhibit the same function. Furthermore, any structure or step may be added.

In addition, when the safety fence system is provided with a light curtain, a photoelectric sensor, and a laser range sensor, which are examples of an entering object detection sensor, instead of the opening/closing door, the determination section may determine that the safety confirmation state is achieved when both the conditions (2) and (3) are satisfied.

1. A control system comprising:
a robot control apparatus that controls an operation of a robot having a robot arm; and
a transmission apparatus that transmits a safety confirmation signal indicating that it is confirmed that the robot is configured to be operated safely to the robot control apparatus, wherein
the robot control apparatus includes
a safety confirmation signal acquisition section that acquires the safety confirmation signal, and
a notification signal output section that generates and outputs a notification signal for notifying that safety confirmation is required until the safety confirmation signal acquisition section acquires the safety confirmation signal when power is supplied to the robot control apparatus.

2. The control system according to claim 1, wherein
the notification signal output section outputs the notification signal after a predetermined time elapses from when power is supplied to the robot control apparatus.

3. The control system according to claim 1, wherein
the notification signal output section generates the notification signal in which a degree of notification changes such that a notification effect is increased as time elapses from when the notification signal is output until when the safety confirmation signal is acquired.

4. The control system according to claim 1, wherein
the robot control apparatus transmits the notification signal to a designated smartphone.

5. The control system according to claim 1, wherein
the safety confirmation signal acquisition section includes an opening/closing signal acquisition section that acquires an opening/closing signal including information on an open/closed state detected by an opening/closing detection section that detects an open state or a closed state of an opening/closing section that opens or closes an access section that is configured to access a movable region of the robot, and
the notification signal output section generates the notification signal in accordance with the opening/closing signal acquired by the opening/closing signal acquisition section.

6. The control system according to claim 1, wherein the safety confirmation signal acquisition section includes a trigger signal acquisition section that acquires a trigger signal, and
the notification signal output section generates the notification signal in accordance with the trigger signal acquired by the trigger signal acquisition section.

7. The control system according to claim 1, wherein
the safety confirmation signal acquisition section includes an opening/closing signal acquisition section that acquires an opening/closing signal including information on an open/closed state detected by an opening/closing detection section that detects an open state or a closed state of an opening/closing section that opens or closes an access section that is configured to access a movable region of the robot, and a trigger signal acquisition section that acquires a trigger signal,
the robot control apparatus includes a determination section that defines, as a safety confirmation state, a case where, when power is supplied to the robot control apparatus, the opening/closing detection section detects that the closed state is achieved based on the opening/closing signal acquired by the opening/closing signal acquisition section, and the trigger signal acquisition section acquires the trigger signal, and determines whether or not the safety confirmation state is achieved, and
the robot control apparatus permits an operation of the robot arm when the determination section determines that the safety confirmation state is achieved, and prohibits an operation of the robot arm until the safety confirmation signal acquisition section acquires the safety confirmation signal and generates and outputs the notification signal by the notification signal output section when the determination section determines that the safety confirmation state is not achieved.

8. A robot control apparatus that controls an operation of a robot having a robot arm, the robot control apparatus comprising:
a safety confirmation signal acquisition section that acquires a safety confirmation signal indicating that it is confirmed that the robot is configured to be operated safely; and
a notification signal output section that generates and outputs a notification signal for notifying that safety confirmation is required until the safety confirmation signal acquisition section acquires the safety confirmation signal when power is supplied to the robot control apparatus.

9. A control method of a robot control apparatus that controls an operation of the robot having a robot arm and includes a safety confirmation signal acquisition section that acquires a safety confirmation signal indicating that it is confirmed that the robot is configured to be operated safely, the control method comprising:
a first step of generating and outputting a notification signal for notifying that safety confirmation is required until the safety confirmation signal acquisition section acquires the safety confirmation signal when power is supplied to the robot control apparatus; and
a second step of stopping an output of the notification signal and permitting an operation of the robot arm when acquiring the safety confirmation signal.
